(19) United States
(12) Patent Application Publication
(10) Pub. No.: US 2014/0118345 A1
(43) Pub. Date: May 1, 2014

(54) SYSTEM AND METHOD FOR ANALYSIS OF TRAP INTEGRITY

(71) Applicants: Christian Hager, Houston, TX (US); Sankar Kumar Muhuri, Houston, TX (US); Paul Shelton Landis, Houston, TX (US)

(72) Inventors: Christian Hager, Houston, TX (US); Sankar Kumar Muhuri, Houston, TX (US); Paul Shelton Landis, Houston, TX (US)

(73) Assignee: Chevron U.S. A. Inc., San Ramon, CA (US)

(21) Appl. No.: 13/662,175

(22) Filed: Oct. 26, 2012

(51) Int. Cl. G06T 17/00

(52) U.S. Cl. CPC G06T 17/00
USPC 345/420

(57) ABSTRACT

A method for quantitatively ranking a plurality of prospects in a subsurface region, includes generating a subsurface digital elevatiomodel of each prospect and identifying a region of subsurface imaging uncertainty within the model. The method further includes generating, for the region of imaging uncertainty, multiple realizations of the model, and determining geometrical and physical characteristics of the prospect for each realization. The characteristics, chosen to be related to a likelihood that the prospect is lower risk, are summed and the prospects are ranked in accordance therewith.

### TECHNICAL FIELD

The present invention relates to analysis of trap integrity using multiple characteristics of a potential hydrocarbon reservoir.

### BACKGROUND

In hydrocarbon exploration, seismic imaging may be used to determine likely locations for exploitable resources. Typically, even where geologists determine that commercial resources may be present, there is the risk of test wells failing to prove high value reservoirs. During exploration, identification of traps, or locations likely to have held significant hydrocarbons over time, is an important tool in reservoir identification. It has been the industry's experience that in the Gulf of Mexico, locations identified as four way traps tend to be successful more often, while three way traps with salt as a trapping boundary tend to be often unsuccessful. Thus, the inventors have determined that an improved approach of evaluating the nature of traps would be useful.

### BRIEF DESCRIPTION OF DRAWINGS

FIG. 1 is a seismic image illustrating a subsurface structure having a steep dip, showing a region of uncertain image interpretation;

FIG. 2 is a chart illustrating a workflow in accordance with an embodiment;

FIG. 3 is a bar graph illustrating relative rankings of a group of prospects using a method in accordance with an embodiment;

FIG. 4 is a bar graph illustrating normalized values of characteristics for the group of prospects of FIG. 3;

FIG. 5 is a 3D structural rendition of the subsurface configuration at depth illustrating a region under study using a method in accordance with an embodiment;

FIG. 6 is a cross section of a portion of the region illustrated in FIG. 5;

FIG. 7 is a three dimensional model of the region under study;

FIG. 8 is an illustration showing several realizations for different assumed dip angles for the region;

FIG. 9 illustrates mechanical seal capacity as related to two prospects and various realizations thereof; and

FIGS. 10a-i illustrate characteristics of the seal structure that can be used in accordance with embodiments.

### DETAILED DESCRIPTION

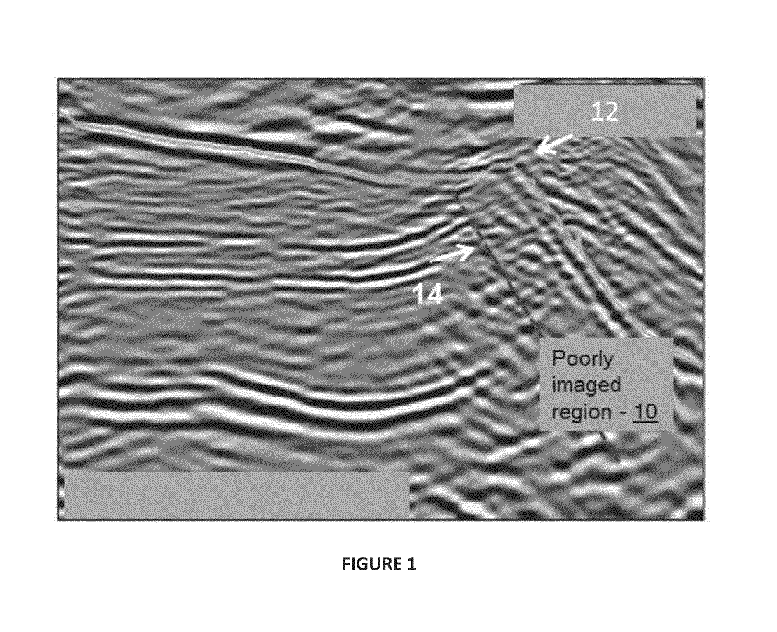

In practice, the quality of a potential hydrocarbon trap is evaluated by expert analysts interpreting subsurface geometry to determine the likelihood of a trap that would tend to prevent leakage of hydrocarbon resources. For example, a reservoir may be trapped against salt features such as diapirs or welds. As noted above, four way traps tend have lower risk profiles than three way traps, but as a practical matter, subsurface analysts are often faced with exploration in three way traps that are bound at least on one side by a salt surface in a given geographic area of interest. Furthermore, in the region near a boundary between such salt structures that may enclose a potentially commercial hydrocarbon deposit forming a trap, there may be a large degree of uncertainty as to the quality of the seismic images used to identify such deposits. In particular, the large change in velocities between salt and sand or mud results in uncertainty as to the velocity models. Likewise, steep dips and other rapidly varying structures introduce uncertainty into the interpretations. An example of such an uncertain region 10 is illustrated in FIG. 1 between a steeply dipping layer 12 and the dashed line 14 which represents a high confidence limit for this image. By high confidence limit is meant a position in a cross section that represents what an interpreter believes is accurately represented, i.e., the image has relatively good certainty at this point. It may be, in particular, the last position along the cross section that has good certainty. As a result of this uncertainty in expert qualitative analysis, the inventors have determined that an empirical basis for evaluating structures such as three way traps may be useful.

Embodiments described in this disclosure relate to a workflow for analysis of data representative of subsurface geological structure. The workflow may be executed, for example, on a computing device having a graphical user interface and running software configured to allow a user to manipulate earth models and subsurface images. By way of example, such a system may use GOCAD earth modeling software, available from Paradigm. Additionally, mathematical modeling software such as Matlab, available from Mathworks, may be employed for performing subsurface structural modeling calculations, evaluating realizations of the earth models, or other tasks. As will be appreciated, the specific software to be employed may vary, and will be selected from those products generally available, or may include proprietary and/or custom applications.

In an embodiment, a threshold is determined for distinguishing reliable seismic data from unreliable and/or uncertain seismic data. In particular, this is performed for regions proximate the bounding surface of the suspected trap. The exact extent of this zone of uncertainty is dependent, among other things, on the degree of complexity of the geometry of the salt body.

A model for the subsurface region including the trap structure is generated, and a number of realizations are generated based on the model. In an embodiment, the different realizations represent changes in structural dip within a region defined by the high confidence limit and the bounding surface. By way of example, several tens of realizations may be used, with about 100 realizations being an example of a useful number of realizations. A suitable range may be 50-150 realizations and a more specific range may be 80-120 realizations.

For each realization, a number of metrics may be generated to characterize that realization. For example, it may be useful to determine boundary length, boundary sinuousity, aspect ratio, lateral-seal/top-seal ratio and/or surface area of container/acreage of container ratio. As will be appreciated, these characteristics provide a form of summarizing information characterizing a shape and other intrinsic aspects of the potential reservoir for each realization.

In an embodiment, the surface area of container to acreage of container ratio may be calculated from the container crest to a lowest closing contour in 100 ft intervals. This approach may provide an accurate description of the three dimensional geometry of the potential trap. The modeled three dimensional geometry may then be constrained by adjusting the relief of each individual realization to meet the determinations of capillary and/or mechanical seal capacity or empirically derived column height values. For each realization, a formation pressure at the crest may be calculated to estimate a relative likelihood of mechanical seal failure.

Once the modeling and characterization is complete, prospects are ranked against each other based on the characteristics. Stated generally, for each characteristic, an ordered ranking is produced incorporating each prospect, and values for each characteristic that are thought to be indicative of a low risk prospect are ranked higher than values for that characteristic that are thought to be indicative of a high risk prospect. For characteristics that change across realizations, an average value may be used, which may be an arithmetic mean, weighted mean or other representative value. Certain characteristics, for example variance, do not change across realizations, and therefore do not need to be averaged or otherwise altered before incorporation into the method.

Rankings may be based, for example, on sinuousity, where more sinuous boundaries are considered to be lower ranked than less sinuous boundaries. Similarly, high lateral seal to top seal ratio structures may be ranked lower than low lateral seal to top seal ratio structures. Low aspect ratio structures or traps are ranked higher than high aspect ratio structures. Crestal pressure values further from a mechanical seal failure pressure are ranked higher than crestal pressure values closer to the failure pressure envelope. Finally, high surface area of container to acreage of container ratio structures are ranked lower than low surface area of container to acreage of container ratio structures. Further detail relating to these characteristics is provided below.

In addition to the foregoing quantitative characteristics, qualitative characteristics may be generated and ranked. As an example, a parameter that is selected to represent whether the prospect is the highest (or a relatively high) structure within the basin may be included. This parameter would help to identify potential portions of the regional structure that would tend to act as pressure relief zones and therefore be more likely to be subject to forces tending to impair trapping and/or promote hydrocarbon migration.

The prospects are ranked by summing normalized mean values for all of the selected characteristics. Thus, the final rankings represent a blended sum of all of the investigated characteristics for the prospects. In an embodiment, each characteristic is equally weighted, so that no particular evaluation approach is dominant. As will be appreciated, it may be possible to select weightings for some or each of the characteristics should those characteristics be found to be of particular predictive value.

It may be, for example, that in a particular geologic context, that lateral seal to top seal ratio has especially significant predictive value, or that sinuosity has especially low predictive value. If this is the case, then those factors can be weighted accordingly. In an embodiment, an initial unweighted ranking may be used, and the outcome may be adjusted using weighting factors in an iterative manner as information becomes known regarding which factors are more closely correlated to success in the formation under study.

Similarly, if investigation of particular characteristics shows that there is no clear trend (i.e., all prospects are very similar or each is randomly different from the others), those characteristics may be assigned a low weight.

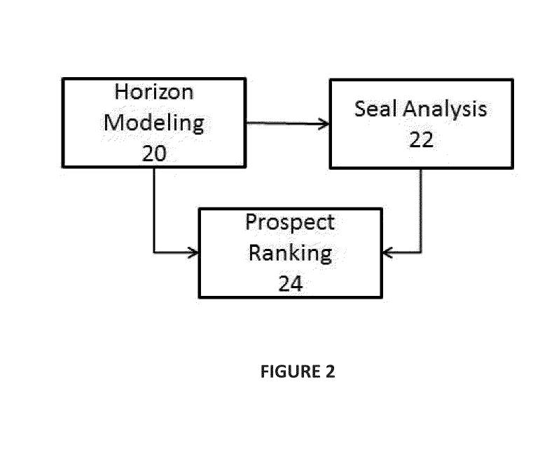

FIG. 2 illustrates an embodiment of a workflow in accordance with an embodiment. Results of horizon modeling 20 are used as an input to seal analysis 22. The results of both the horizon modeling 20 and the seal analysis 22 are used as inputs to the prospect raking 24.

As described above, the horizon modeling 20 may include an assessment of image uncertainty, generating multiple realizations, and calculation of geometric parameters for each realization. The seal analysis 22 may include determining maximum possible column heights and calculation of seal failure risk for each realization. The prospect ranking 24 may include statistical analysis and ranking of the prospects. In an embodiment, the prospect ranking is then used to make determinations regarding drilling operations for further exploration or recovery operations in the region under study.

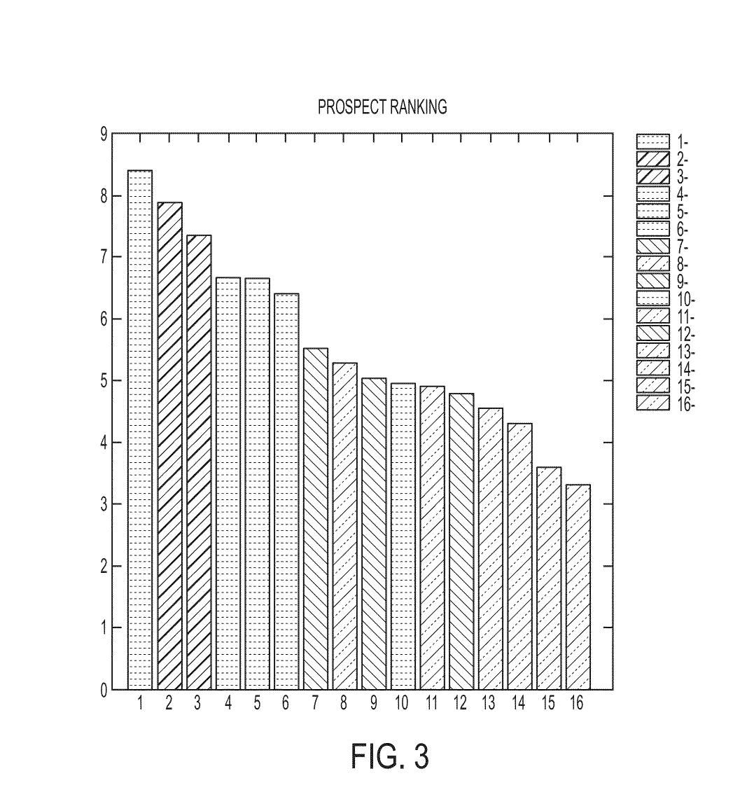

FIG. 3 is a bar graph illustrating a sample group of 16 prospects ranked in accordance with an embodiment. Each bar represents a sum of the normalized values of the characteristics for a respective prospect. The color coding indicates whether the prospect was a success (2, 3), a failure (8, 11, 13-16), or has not yet been tested (1, 4-7, 9-10, 12). As can be seen, the ranking correlates fairly well to success/failure outcomes, with the majority of the lower-ranked prospects being failures, and the two successes being highly ranked.

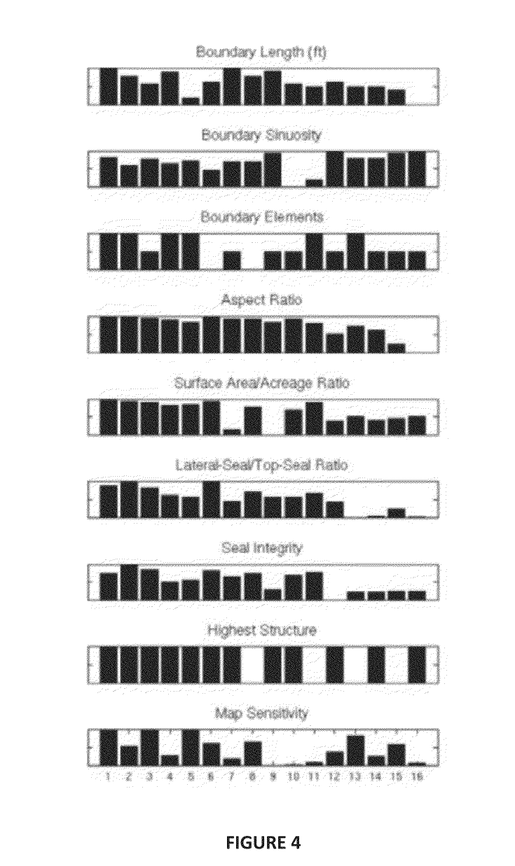

FIG. 4 is a series of bar graphs illustrating relative normalized values for each characteristic used in creating the rankings of FIG. 3. As may be observed from the graphs of FIG. 4, there is a wide variety of apparent relationships for the selected characteristics. Some of the characteristics show no, or very little, trend on their own. But, as was shown in FIG. 3, the sum of the characteristics appears to show quite a strong correlation to likelihood of success.

Three of the nine selected characteristics do show an apparent trend. Aspect ratio (the fourth graph from the top), lateral-seal/top-seal ratio, and seal integrity all generally follow a trend line decreasing left to right, similar to the graph of FIG. 3. As will be appreciated, if further data bear out this apparent trend, the model could be adapted by weighting these values over the other, less trend-exhibiting, characteristics.

With the general discussion above as background, embodiments are addressed in greater detail.

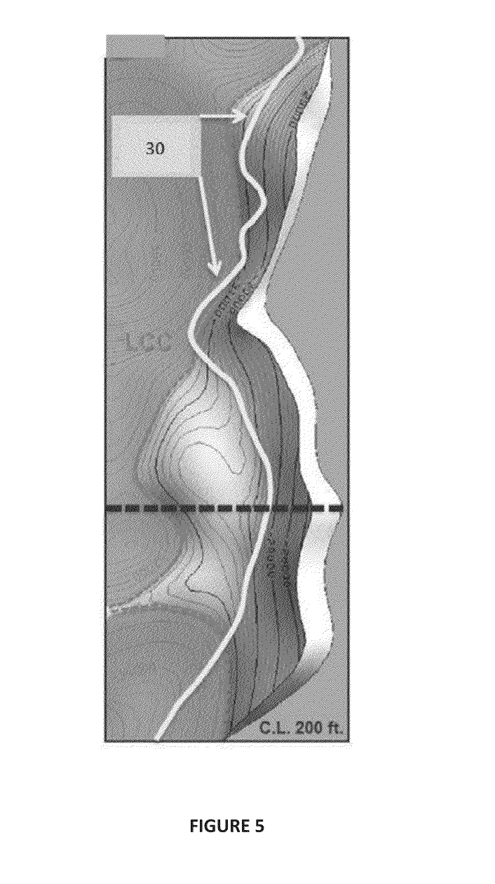

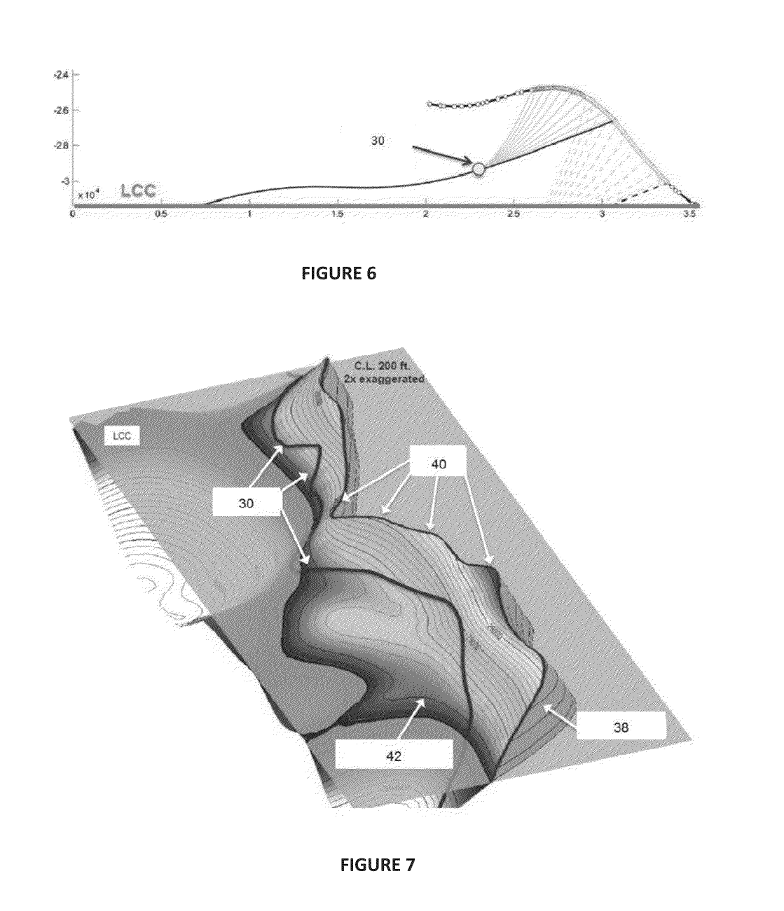

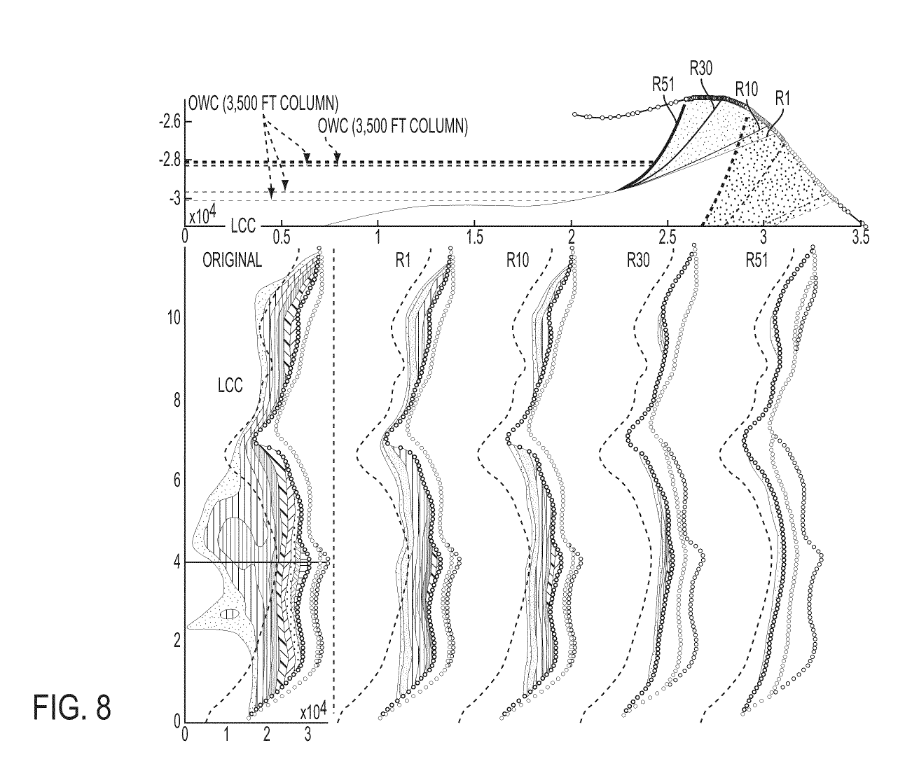

In an embodiment, an initial step is for a user to determine what areas of an initial seismic image represent poor data (relatively high uncertainty). A high confidence limit is selected, defining the uncertain region. This concept is illustrated in FIG. 5, where the high confidence limit line is the bright line 30 extending along the central portion of the image. The original interpretation of the volume is shown as the light dashed line LCC. A cross section of the same prospect is shown in FIG. 6, with the high confidence limit 30 illustrated as a point along the top surface of the interpreted potential reservoir. The curve on the right represents a set of 51 realizations for different selected steepness of dip. This concept is illustrated more clearly in FIG. 8, discussed below.

Once the high confidence limit is defined, prospect setup continues by merging the boundary elements into a single surface 38. This surface represents the initial model of the prospect. In an embodiment, the surfaces may be cut to the prospect extent represented by the intersections of the bounding surface 38, initial interpretation 42, and the planar LCC. In the 3D representation of FIG. 7, the lowest closing contour is represented by the plane LCC cutting through the original boundary of the bounding surface 38. The original interpretation 42 is shown as three-dimensional surface representing an interpretation of the prospect absent application of the present method.

FIG. 8 illustrates the effect of application of various realizations, corresponding to dip changes for a constant column height of 3,500 feet (note that the oil water contact depth is illustrated by the horizontal dashed lines, and that the structure under study is at a depth of around 30,000 feet as shown by the horizontal axis of the Figure). In this case, the column height to be used was empirically determined based on other experience within the same formation. In the illustrated prospect, R1 represents a dip of about 20°, R10 represents a dip of about 30°, R30 represents a dip of about 55° and R51 represents a dip of about 80°. As may be seen in the Figure, a slight increase in dip from 20 to 30 degrees, results in a split in the container wherein the upper part of the container is no longer contiguous with the lower part of the container, resulting in two separate sub-culminations. As the dip increases, the volume contained decreases significantly. This therefore corresponds to a structure that is very dip sensitive, and therefore subject to large variation depending on the uncertainty of the model. Given the uncertainty, it is possible to assume that the original model (left-most in FIG. 8) is likely to have overstated the value of this prospect substantially.

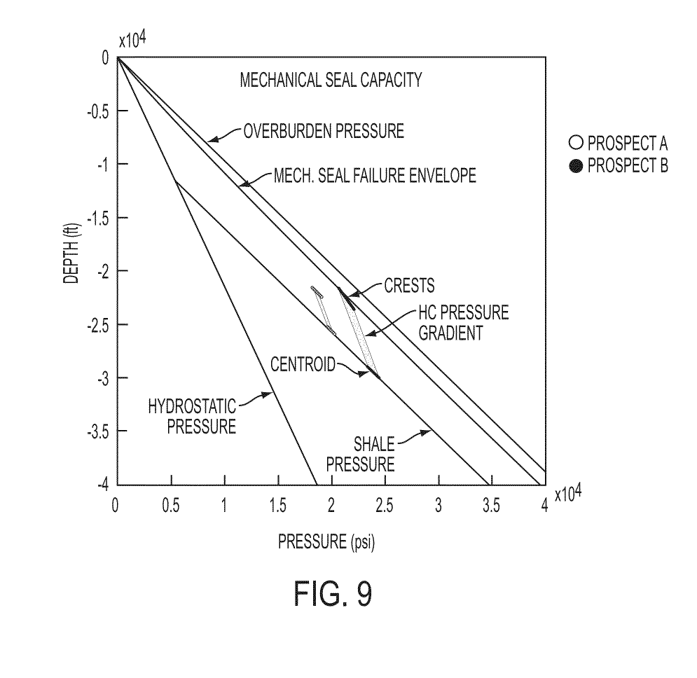

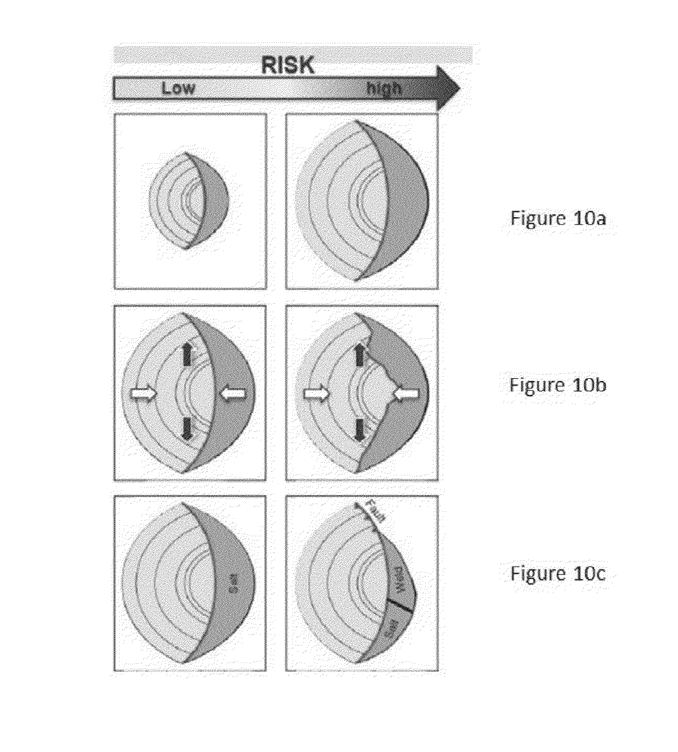

For each realization, a top seal capacity may be calculated. The mechanical seal capacity is determined based on the overburden pressure, the mechanical seal failure envelope, hydrostatic pressure, and shale pressure, as illustrated in FIG. 9. FIG. 9 shows 51 realizations for each of two prospects, A and B. As may be observed in the Figure, formation pressures at the crests of the realizations for Prospect A are relatively further from the mechanical seal failure envelope than are formation pressures at the crests of the realizations for Prospect B. Thus, Prospect B is more likely to suffer a seal failure and Prospect A has a relatively lower risk of seal failure.

In general, closure geometry, top seal, lateral seal, and hydrocarbon charge can be said to define the observed hydrocarbon column in a given prospect. For regions like the Gulf of Mexico, and more particularly for three way traps in the gulf, the inventors have found that lateral seal tends to be the more important factor as hydrocarbon charge is generally thought to be present and top seals tend to be adequate and of a low failure risk as evident from the common occurrence of hydrocarbon accumulations in similar reservoirs in four way structures.

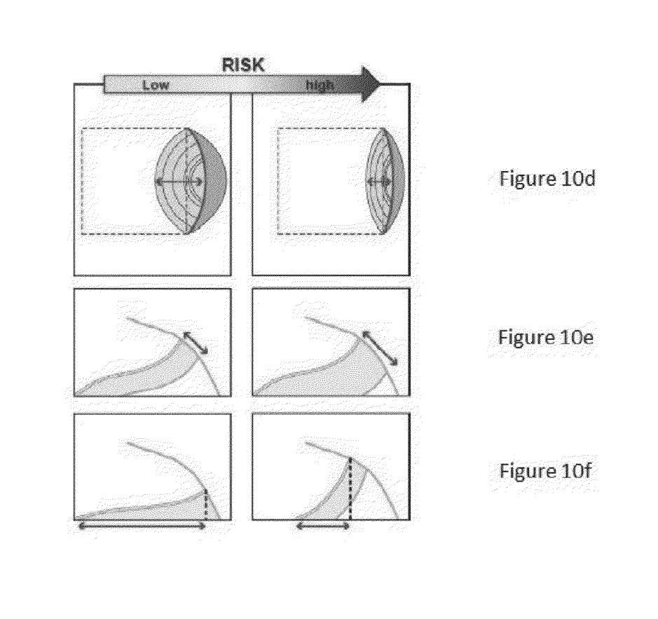

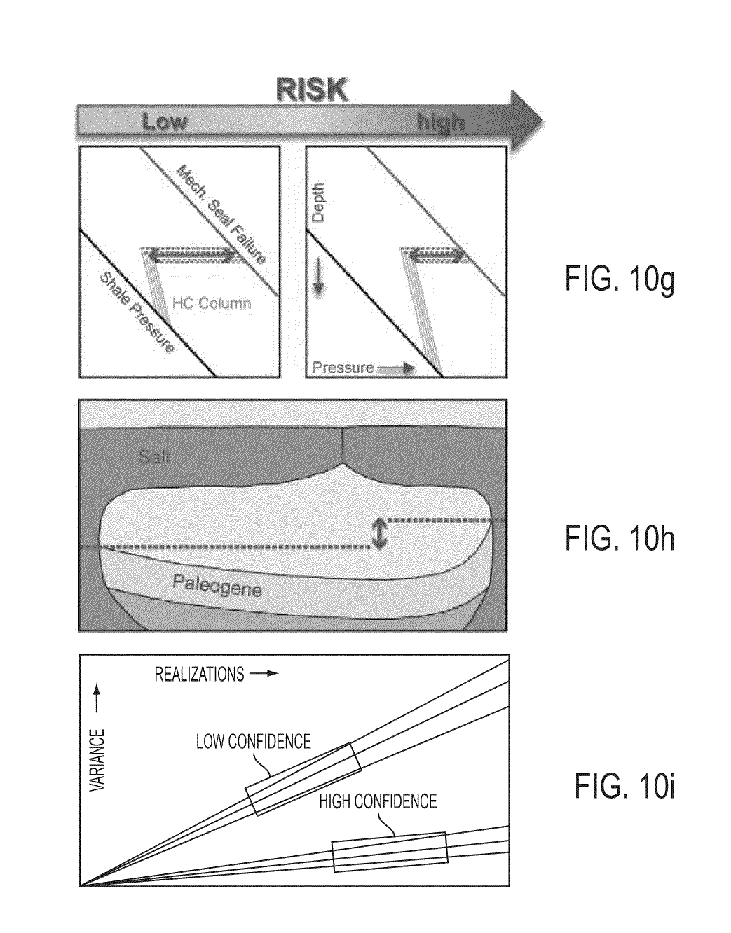

FIGS. 10a-i illustrate characteristics of the seal structure that can be used in accordance with embodiments. In each figure, the illustrated relationship is one in which the left side represents a lower risk structure while the right side represents a higher risk structure.

FIG. 10a schematically illustrates the concept of boundary length. In general, risk is increased as boundary length is increased as shorter boundaries are less likely to fail than are longer boundaries. Length may be compared in a straightforward manner, and for a given set of prospects, the series of lengths may be normalized against the longest member of the set, or they may all be normalized against some preselected length, though it should be noted that such an approach inherently involves a weighting of the length factor against the other factors.

FIG. 10b schematically illustrates the concept of sinuousity. For a given stress field, a more complex boundary will tend to be more risky than a simpler boundary. Though any measure of sinuousity may be used, one approach is to divide boundary length by boundary extent (i.e., a distance along the boundary curve divided by the shortest distance or straight line between the same two end points).

FIG. 10c schematically illustrates the concept of boundary simplicity. In this figure, the right hand illustration includes multiple boundary elements (a fault, a weld and a salt structure) while the left hand side includes a single boundary element (a salt dome). Application of this characteristic may involve a simple element count, or other characterizations of the complexity may be applied. As will be appreciated, element counts may involve human interpretation, and different interpreters may assign differing values to any given set of structures though such differences will be relatively minor.

FIG. 10d schematically illustrates the concept of aspect ratio. This is a measure of the elongation of the prospect and distinguishes between well-defined closures and elongated or ribbon-like closures. As with the other characteristics, a variety of methods for quantifying aspect ratio may be used, but one useful example is the boundary extent squared divided by the top seal acreage.

FIG. 10e schematically illustrates the concept of seal ratio. Generally, as the reservoir section intersecting the bounding surface is thinner, the risk of leakage along the lateral bounding element decreases. A useful approach to quantifying this is to determine a ratio between the lateral seal area and the top seal area. In the illustrated example, the lateral seal area (the area at which the sand formation is in contact with the sealing salt formation—shown by the two headed arrow) is larger on the right hand side, and the top seal area is identical.

FIG. 10f schematically illustrates the concept of trap profile. In general, low relief closures are lower risk than high relief closures. One quantification of the trap profile is top seal area (the surface area of the sealing structure) divided by acreage under the top seal, as shown by the extent of the two headed arrow.

FIG. 10g schematically illustrates the concept of seal integrity. As described above and as illustrated in FIG. 9, formation pressures along the crests that are close to the fracture failure envelope are more likely to involve a failed seal. One method of quantifying this factor is to use a distance from the fracture failure envelope.

FIG. 10h schematically illustrates the concept of the highest structure in a given region. As shown, the right hand side of the illustrated hydrocarbon source area is one in which the formation has a higher rise than the left hand side. Thus, the trap on the right side is more risky as it is likely to fail and act as a pressure relief valve for the region.

FIG. 10i, schematically illustrates the concept of map sensitivity. For any selected parameter (for example, boundary length, but in principle, any parameter or characteristic of the reservoir), a higher variance with change in dip (upper portion of the figure) indicates a greater degree of uncertainty about the model than does a lower variance (bottom of the figure). For example, a standard deviation of the boundary length over the set of realizations may be used as the quantification of this factor.

As can be seen from the foregoing, certain of the various characteristics can be derived in part from measurements used in common. That is, for example, boundary extent is used in calculating both boundary sinuousity and aspect ratio. Similarly, boundary extent is used in boundary sinuousity and aspect ratio. Thus, these values need only be calculated a single time, and the result used across characteristics.

While the foregoing method has been described primarily in the context of the Gulf of Mexico and three way traps, it may find applicability in a variety of exploration applications. In particular, the method should be applicable to any set of prospects that are in a region where there is a high degree of uncertainty regarding subsurface structures. Such uncertainty may arise, as noted above, in high dip reservoirs, in regions where velocities change rapidly (e.g., regions having the presence of high velocity clathrates co-located with lower velocity sands), complex structures, structures thin relative to the seismic wavelength, and in regions of poor illumination due to shadowing from overburden structures such as salt lenses, large thrust sheets, or overlying canyon systems. Furthermore, while specific physical characteristics have been described in detail, it should be appreciated that other physical characteristics of the prospects may be used.

The above described methods can be implemented in the general context of instructions executed by a computer. Such computer-executable instructions may include programs, routines, objects, components, data structures, and computer software technologies that can be used to perform particular tasks and process abstract data types. Software implementations of the above described methods may be coded in different languages for application in a variety of computing platforms and environments. It will be appreciated that the scope and underlying principles of the above described methods are not limited to any particular computer software technology.

Moreover, those skilled in the art will appreciate that the above described methods may be practiced using any one or a combination of computer processing system configurations, including, but not limited to, single and multi-processer systems, hand-held devices, programmable consumer electronics, mini-computers, or mainframe computers. The computing systems may include storage media, input/output devices, and user interfaces (including graphical user interfaces). The above described methods may also be practiced in distributed computing environments where tasks are performed by servers or other processing devices that are linked through a one or more data communications networks. In a distributed computing environment, program modules may be located in both local and remote computer storage media including memory storage devices.

Also, a tangible article of manufacture for use with a computer processor, such as a CD/DVD, pre-recorded disk or other storage devices, could include a computer program storage medium and machine executable instructions recorded thereon for directing the computer processor to facilitate the implementation and practice of the above described methods. Such devices and articles of manufacture also fall within the spirit and scope of the present invention.

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements. The use of the term “about” with respect to numerical values generally indicates a range of plus or minus 10%, absent any different common understanding among those of ordinary skill in the art or any more specific definition provided herein.

While in the foregoing specification this invention has been described in relation to certain preferred embodiments thereof, and many details have been set forth for the purpose of illustration, it will be apparent to those skilled in the art that the invention is susceptible to alteration and that certain other details described herein can vary considerably without departing from the basic principles of the invention. For example, the invention can be implemented in numerous ways, including for example as a method (including a computer- implemented method), a system (including a computer processing system), an apparatus, a computer readable medium, a computer program product, a graphical user interface, a web portal, or a data structure tangibly fixed in a computer readable memory.

What is claimed is:

1. A method for quantitatively ranking a plurality of prospects in a subsurface region, comprising:
generating a subsurface digital elevation model of each prospect;
identifying a region of subsurface imaging uncertainty within the model;
generating, for the region of imaging uncertainty, a plurality of realizations of the model;
for each realization, determining a plurality of quantitative physical characteristics of the prospect relating to a likelihood that the prospect may be high graded;
for each prospect, summing the determined quantitative physical characteristics; and
ranking the prospects in accordance with the summed determined quantitative physical characteristics.

2. A method as in claim 1, wherein the summing comprises normalizing each quantitative physical characteristic.

3. A method as in claim 1, wherein the plurality of realizations are generated based on varying a parameter of the model for each realization.

4. A method as in claim 3, wherein the region of uncertainty includes a structure having a non-zero dip, and the varied parameter is an angle of dip.

5. A method as in claim 1, wherein the region of uncertainty is identified by a user's selection of high confidence limit.

6. A method as in claim 1, wherein the plurality of quantitative physical characteristics comprise one or more characteristics selected from the group consisting of: boundary length, boundary sinuousity, number of boundary elements, aspect ratio, surface area to acreage ratio, lateral seal to top seal ratio, seal integrity and map sensitivity.

7. A method as in claim 6, wherein the ranking further incorporates one or more qualitative physical characteristics to which a quantitative value has been assigned.

8. A method as in claim 6, wherein the plurality of quantitative physical characteristics comprises at least two characteristics selected from the group consisting of: aspect ratio, lateral seal to top seal ratio and seal integrity.

9. A method as in claim 1, further comprising assigning a weighting factor to at least one of the quantitative physical characteristics based on a degree of correlation between that quantitative physical characteristic and likelihood of a successful prospect.

10. A method as in claim 1, further comprising, drilling a well in a first-ranked prospect of the ranked plurality of prospects.

11. A non-transitory machine readable medium containing machine executable instructions for performing a method for quantitatively ranking a plurality of prospects in a subsurface region comprising:
generating a digital, graphical model of each prospect;
identifying a region of subsurface imaging uncertainty within the model;
generating, for the region of imaging uncertainty, a plurality of realizations of the model;
for each realization, determining a plurality of quantitative physical characteristics of the prospect relating to a likelihood that the prospect may be high graded;
for each prospect, summing the determined quantitative physical characteristics; and
ranking the prospects in accordance with the summed determined quantitative physical characteristics.

12. A medium as in claim 11, wherein the summing comprises normalizing each quantitative physical characteristic.

13. A medium as in claim 11, wherein the plurality of realizations are generated based on varying a parameter of the model for each realization.

14. A medium as in claim 11, wherein the region of uncertainty includes a structure having a non-zero dip, and the varied parameter is an angle of dip.

15. A medium as in claim 11, wherein the region of uncertainty is identified by a user's selection of high confidence limit.

16. A medium as in claim 11, wherein the plurality of quantitative physical characteristics comprise one or more characteristics selected from the group consisting of: boundary length, boundary sinuousity, number of boundary elements, aspect ratio, surface area to acreage ratio, lateral seal to top seal ratio, seal integrity and map sensitivity.

17. A medium as in claim 16, wherein the ranking further incorporates one or more qualitative physical characteristics to which a quantitative value has been assigned.

18. A medium as in claim 16, wherein the plurality of quantitative physical characteristics comprises at least two characteristics selected from the group consisting of: aspect ratio, lateral seal to top seal ratio and seal integrity.

19. A medium as in claim 11, further comprising assigning a weighting factor to at least one of the quantitative physical characteristics based on a degree of correlation between that quantitative physical characteristic and likelihood of a successful prospect.
